(19) United States
(12) Patent Application Publication
(10) Pub. No.: US 2003/0231790 A1
(43) Pub. Date: Dec. 18, 2003

(54) Method and system for computer aided detection of cancer

(76) Inventor: Murk Jan Bottema, Victoria (AU)

Correspondence Address: BIRCH STEWART KOLASCH & BIRCH, PO BOX 747, FALLS CHURCH, VA, 22040-0747, US

(21) Appl. No.: 10/427,907

(22) Filed: May 2, 2003

(30) Foreign Application Priority Data
May 2, 2002 (AU) PS2052

(51) Int. Cl. G06K 9/00; G06K 9/62

(52) U.S. Cl. 382/128; 382/225

(57) ABSTRACT

A computerised method is described for analysing a medical image to detect the presence of a cancer having a radiographic density close to the radiographic density of normal tissue. The method includes processing the image so as to obtain feature measurements for plural features of different pixel neighbourhoods within a region of the image, each pixel neighbourhood including a pixel having a local minimum intensity value. The feature measurements are used to classify each pixel neighbourhood as one of plural neighbourhood categories. Classification information for each neighbourhood category is then processed to thereby calculate parameters for the region. At least one of the region parameters are used to predict the presence of a cancer.

### FIELD OF INVENTION

The invention broadly relates to a computerised method and system for enhanced detection and diagnosis of cancer by distinguishing abnormal and normal tissue in a body using radiological analysis. In a typical application the present invention is used to detect breast cancers which are difficult to detect on mammographic examination.

### BACKGROUND OF THE INVENTION

Breast cancer is a major health hazard for women. In Australia, for example, the incidence and mortality rates are approximately 280 per 100,000 and 60 per 100,000 per year for women between the ages of 50 and 69.

Many countries have implemented screening mammography programs (‘screening’) to assist in the early detection of breast cancer in an effort to reduce the mortality rate. As would be appreciated, the purpose of screening is not to diagnose cancer, but rather to determine whether there is sufficient evidence to warrant calling a woman back for additional testing. Such additional testing may include high resolution x-ray, ultrasound, or fine needle aspiration.

Presently, screening mammograms are visually inspected by radiologists. This type of screening requires that the radiologist examine the mammogram carefully for evidence of cancer such as regions of suspicious contrast, size, and geometry. Such abnormalities may be indicative of a mass, clustered microcalcification, or stellate pattern, which may be associated with a particular manifestation of cancer.

Although the overall accuracy of screening is high, it has been estimated that between 10 and 30 percent of cancers that could have been detected during screening are missed. Moreover, a large number of women who are called back due to a screening process turn out not to have cancer at all.

In relation to missed detection of cancers which could have been detected, such a result may occur due to inattention and fatigue on the part of a radiologist as a result of the screening process itself, which may involve the radiologists viewing a large number of mammograms in a single sitting.

Another difficulty with visual inspection is that the accuracy of screening may be inconsistent due to the subjectivity of visual interpretation, experience of radiologists, variations in equipment and differences in protocol.

In addition to the problems described above, some types of cancers have characteristics which render them difficult to detect by visual inspection. These types of cancers may have, for example, a radiographic density which is about the same as, and therefore close to, that of normal tissue and no associated microcalcifications.

In recent years, computer aided techniques have emerged for assisting radiologists with screening mammogram analysis. Such techniques have developed to the point where they are able to be used to detect and/or classify masses, or detect and/or classify microcalcifications to a reasonable level of accuracy. These techniques have improved consistency and accuracy over visual inspection since they are able to search all portions of an image with equal attention, thus analysing all images consistently.

However, computer aided techniques for detection of cancer typically rely on measuring contrast changes for initial identification of regions that might correspond to masses, clustered microcalcifications, or stellate lesions. Such regions, could, in principle, be detected by a radiologist during visual inspection.

For regions so identified, a variety of features may be measured, including shape, sharpness of a boundary, intensity variation and texture, to determine if cancer is present or not.

However, in relation to cancers with characteristics which render them difficult to detect by visual inspection (since there are no regions of contrast change on which to base initial detection), computer algorithms which rely on initial detection by recognising contrast changes appear to be just as likely to fail as visual inspection itself.

One type of cancer which may exhibit characteristics which make them difficult to detect by visual inspection is invasive lobular carcinoma. Consequently, this type of cancer is often missed during screening mammography. Indeed, large invasive lobular carcinomas (for example, tumours having a diameter of 10 cm) have been found during surgery even though there was no evidence of cancer detected during visual examination by experienced radiologists.

In light of the preceding discussion it can therefore be appreciated that there appear to be a number of deficiencies associated with existing mammography screening techniques.

It is thus an aim of the present invention to ameliorate the aforementioned deficiencies and to provide a system and method for detecting cancers in a screening mammogram, which up until now have been difficult to detect.

### SUMMARY OF THE INVENTION

In broad terms, the present invention is directed to a computerised system and method for detecting cancer. The present invention relies on using computerised radiological analysis to distinguish abnormal tissue from normal tissue in a body.

Thus, in one form the present invention provides a computerised method of analysing a medical image to detect the presence of a cancer having a radiographic density close to the radiographic density of normal tissue, the method including the steps of:

a. processing the image so as to obtain feature measurements for plural features of different pixel neighbourhoods within a region of the image, each pixel neighbourhood including a pixel having a local minimum intensity value;

b. using the feature measurements to classify each pixel neighbourhood as one of plural neighbourhood categories;

c. processing classification information for each neighbourhood category to thereby calculate parameters for the region; and

d. using at least one of the region parameters to predict the presence of cancer in the image.

However, in a preferred form the present invention provides a computerised method of analysing a medical image to detect the presence of a cancer, the cancer having a radiographic density close to the radiographic density of normal tissue, the method including the steps of:

a. pre-processing the image to select a region, the region including a plurality of pixels, each pixel having an intensity value;

b. identifying pixels in the region having a local minimum intensity value;

c. for each identified pixel having a local minimum intensity value, identifying an associated pixel neighbourhood;

d. for each identified neighbourhood:

i. obtaining measurements for plural features of the neighbourhood; and

ii. using the feature measurements to classify the neighbourhood thereby providing neighbourhood classification information;

e. processing the neighbourhood classification information to calculate parameters for the region; and

f. using at least one of the region parameters to predict the presence of cancer in the image.

The present invention also provides a computerised method of analysing a digital mammogram to detect the presence of an invasive lobular carcinoma in human breast tissue, the method including the steps of:

a. processing an image file for the digital mammogram so as to obtain feature measurements for plural features of different pixel neighbourhoods within a region of the digital mammogram, each pixel neighbourhood including a pixel having a local minimum intensity value;

b. using the feature measurements to classify each pixel neighbourhood as one of plural neighbourhood categories;

c. processing classification information for each neighbourhood category to thereby calculate parameters for the region; and

d. . using at least one of the region parameters to predict the presence of an invasive lobular carcinoma.

The present invention also provides a system for analysing a medical image to detect the presence of a cancer, the cancer having a radiographic density close to normal tissue, the system including:

a. a programmed computer;

b. computer software installed onto the programmed computer, the computer software enabling the programmed computer to:

i. pre-process the image to select a region, the region including a plurality of pixels, each pixel having an intensity value;

ii. identify pixels in the region having a local minimum intensity value;

iii. for each identified pixel having a local minimum intensity value identify and associated pixel neighbourhood;

iv. for each identified neighbourhood:

ξ obtain measurements for plural features of the neighbourhood; and

ξ use the feature measurements to classify the neighbourhood, thereby providing neighbourhood classification information;

v. process the neighbourhood classification information to calculate parameters for the region; and

vi. use at least one region parameters to predict the presence of cancer in the image.

The medical image may be a two-dimensional (2D) digital image obtained from a film digitiser which is connected to the programmed computer, which connection may be via a network. In this form of the invention, the digital image may be an x-ray mammogram. In an alternative embodiment of the invention, the medical image may a three-dimensional (3D) digital image (for example, a computed axial tomography (CAT) scan obtained from a CAT scanner).

A particular advantage of the present invention is that it provides a system and method which assists radiologists with analysing medical images having signs of a cancer which are difficult to detect on mammographic examination. Thus, the present invention enables computerised detection and measurement of a number of small-scale low-contrast texture features to predict the presence of cancer in a medical image, without relying on initial detection of regions of high intensity contrast or geometric anomalies in the image.

It is also envisaged that the present invention will be useful for analysing medical images having signs of a cancer which are detectable (that is, observable) on mammographic examination. In light of the aforementioned advantages, it is envisaged that the present invention will contribute to a reduction in the number of false positive detections as compared to mammographic examination.

It is envisaged that the present invention will find application in the detection of cancers including invasive lobular carcinoma.

General Description of the Invention

A system and method in accordance with the preferred embodiment of the present invention is particularly suited to detecting invasive lobular carcinoma. Indeed, in the preferred embodiment of the invention, the medical image may be a digital image such as an x-ray mammogram, which is to be analysed for the presence of invasive lobular carcinoma. Such an image may be generated using a combined film and digitising system.

In forms of the invention where the image has been generated using a system (such as the above-mentioned combined film and digitising system) having a non-linear characteristic, the step of pre-processing the image to select a region may. further include processing the image to correct the non-linear characteristic.

In this form of the invention, image pixel intensity values for pixels in the image may be modified using a correction function to provide modified image pixel intensity values. In one form of the present invention, the correction function may be obtained using a step wedge to generate a standard correction curve for the system.

It is preferred that the pre-processing of the image to select a region includes the steps of:

a. sub-sampling the image to provide a sub-sampled image;

b. thresholding the sub-sampled image using a selected threshold value, the thresholding providing a modified sub-sampled image;

c. selecting the largest connected component in the modified sub-sampled image;

d. up-sampling the modified sub-sampled image to provide an up-sampled image; and

e. dilating the up-sampled image using a dilation element.

As would be known to a person skilled in the art, sub-sampling is a general term for reducing the size of an image by removing pixels from the image in a specified way.

The sub-sampling may be performed using any suitable process. One suitable process may include replacing each 10×10 array of pixels with a single pixel having an intensity which is equal to the average of the one-hundred pixels in the 10×10 array. Thus, using this particular process the sub-sampled image has an image area which is one-hundred times smaller than the digital image.

In relation to the use of the phrase ‘selecting the largest connected component’, it is to be understood that the use of this phrase is reference to the selection of a region of non-zero pixels which join onto one another. In this respect, two non-zero pixels are in the same region if you can get from one to the other by making jumps to adjacent pixels without going onto a zero pixel.

Furthermore, in relation to the use of the term ‘thresholding’, throughout this specification reference to this term is to be understood to be reference to a process whereby pixels in a first image having an intensity value which is less than the selected threshold value are assigned a binary ‘zero’ value, and pixels having a value above the threshold value are assigned a binary ‘one’ value. Thus, the output of the thresholding process is a binary image.

In a preferred form of the invention, where the intensity values are scaled from 0 to 4095, a suitable threshold value is 1000.

For the benefit of an addressee who may not be versed in the art, reference to the term ‘up-sampling’ throughout this specification is to be understood to be reference to a process whereby the area of the modified sub-sampled image is increased by replacing every pixel with an array of pixels.

The up-sampling process may be performed using any suitable process. In the preferred form of the invention, the up-sampling process is performed by replacing every pixel in the modified sub-sampled image with a 10×10 pixel array. Thus, the output (that is, the up-sampled image) of this process is an image having an image area which is one-hundred times larger that the modified sub-sampled image.

In relation to the step of dilating the up-sampled image, the use of the term ‘dilating’ in the context of this specification is to be understood to be reference to a process in which the up-sampled image is modified using a dilation element such that pixels which have a zero value and which are located within a zone defined by the dilation element, are assigned a non-zero value if another pixel within the zone defined by the dilation element has a non-zero value.

The dilation element may have any suitable form. In one form of the invention, where the digital image is a mammogram, the dilation element may be a circular structure element having a predetermined radius. In one form of the invention, the predetermined radius is 15 pixels.

Having described the pre-processing of the image to select a region, the identification of pixels in the region having a local minimum intensity value will now be described. For the purpose of this description, pixels having a local minimum intensity value will herein be referred to as a local minimum.

Ideally the local minima are single pixel local minima in an intensity surface of the region. In this specification, reference to the term ‘intensity surface’ is to be understood to be reference to a three dimensional topology which describes variation in pixel intensity values across the surface of the region.

Here, pursuant to a preferred form of the present invention, identifying pixels in the region having a local minimum intensity value entails processing the pixel intensity values to identify all single pixel local minima so as to locate all pixels in the region having an intensity value which is less than all of its adjacent pixels.

Having identified the single pixel local minima in the region, the identification of a pixel neighbourhood for each pixel having a local minimum intensity value preferably includes:

a. processing intensity values for plural pixel sets, each pixel set having one of several non-overlapping paths, each path being substantially concentric about the local minimum, and substantially equally spaced, wherein the processing provides a statistical value for each pixel set; and

b. processing each statistical value to identify a neighbourhood boundary.

In a preferred form of the invention, the paths are substantially circular. However, it is to be understood that although reference will be made to paths as being substantially circular, it is to be appreciated that other path geometries may also be used. Indeed, it is envisaged that path shapes such as polygons and ellipses may also be suitable. Clearly, such path shapes may require a different set of feature measurements according to the path geometry.

Pursuant to the preferred form of the invention, the statistical value is the average pixel intensity value for the pixels in a pixel set.

The processing of statistical values to identify a neighbourhood boundary preferably includes comparing statistical values from adjacent pixel sets to identify a minimum difference. The neighbourhood boundary is preferably the path having a statistical value which is different from the statistical value of a smaller adjacent path by an amount which is less than the minimum difference.

In a preferred form of the invention, where the paths are substantially circular, the plural feature measurements preferably includes:

a. height (H);

b. radius (R);

c. symmetry (S); and

d. background (B).

In this form of the invention, the radius is preferably determined using a radius obtained for the boundary.

Preferably, where the statistical value is the average pixel intensity value, the height may be computed as a difference between the average pixel intensity value for pixels located on the boundary and the pixel intensity value of the single pixel local minimum in the neighbourhood.

Ideally, the symmetry may be computed using an average squared difference between the local intensity surface and a local model of the intensity surface obtained by revolving a function of the statical values about the single pixel local minimum.

Preferably, the background is able to be computed using the statistical value of the neighbourhood boundary.

In a particularly preferred form of the present invention, the classifying of a neighbourhood using the feature measurements preferably includes:

a. categorising each identified neighbourhood into a neighbourhood category according to a comparison of a neighbourhood's respective feature measurements with plural sets of predetermined feature criteria; and

b. for each neighbourhood which is categorised using a neighbourhood category, incrementing a category count for the respective neighbourhood category.

In one form of the invention, the plural sets of predetermined feature criteria includes:

:₁={H>19, R=1, S≦150, B>2100};

:₂={H>38, R=2, S≦200, B>2100}; and

:₃={H>76, R=3, S≦300, B>2100}.

wherein: ₁,: ₂and : ₃ are the corresponding neighbourhood categories.

It is preferred that co-ordinate data for the local minimum pixel associated with a corresponding neighbourhood which has been classified using a neighbourhood category is stored for subsequent retrieval. A particular advantage of this feature is that the coordinate data may be used to identify a location of a possible cancer site in the digital image.

Pursuant to the preferred form of invention, the calculation of region parameters is performed using classification information obtained for at least one neighbourhood category.

In this form of the invention, the region parameters preferably include:

a. a mean height for each local minimum in neighbourhoods having the same category; and

b. a normalised category count for each neighbourhood category.

In relation to using at least one region parameters to predict the presence of cancer in the image, the prediction preferably includes providing an indication of the likelihood that cancer exists in the image. In a preferred form of the invention, the indication is a numerical indication which is preferably obtained using predetermined information.

In one form of the invention, the predetermined information has been obtained using analysis of a receiver operating characteristic (ROC) for images which have been previously processed.

The predetermined information is preferably stored in at least one table, each table including values which are indicative of a classification score of a prediction derived using at least one region parameter.

It will be recognised that the present invention includes a number of advantages in that the method is able to be deployed to detect cancer in digital images without requiring the initial detection of regions of high intensity contrast or geometric anomalies in the image, thus enabling the detection of cancer as a part of the screening process.

### BRIEF DESCRIPTION OF THE DRAWINGS

The present invention will now be described in relation to various embodiments illustrated in the accompanying drawings. However, it must be appreciated that the following description is not to limit the generality of the above description.

In the drawings:

FIG. 1 shows a flowchart representing the overall steps according to a preferred embodiment of the method of the present invention;

FIG. 2 shows an intensity surface of a pixel neighbourhood having a local minimum;

FIG. 3 shows a function of average pixel intensity values for the pixel neighbourhood of FIG. 2;

FIG. 4 shows a model for the neighbourhood of FIG. 2 obtained by revolving the function of in FIG. 3 about the y-axis.

FIG. 5 shows a scatter plot for two region parameters obtained for plural images;

FIG. 6 shows a receiver operatic characteristic for the elements of FIG. 5;

FIG. 7 shows an image containing an invasive lobular carcinoma; and

FIG. 8 shows a binary image which shows the breast region of FIG. 7 with the locations of local minima satisfying the criteria of category: _{1.}

### DETAILED DESCRIPTION OF THE INVENTION

The preferred embodiment of the invention relates to the use of an image processing system for detecting invasive lobular carcinoma in a digital image of a human breast. However, it is to be appreciated that, whilst the following description describes an embodiment suitable for the detection of invasive lobular carcinoma, the present invention is not limited to this capability. Indeed, the present invention may be equally capable of detecting other cancers in other tissue.

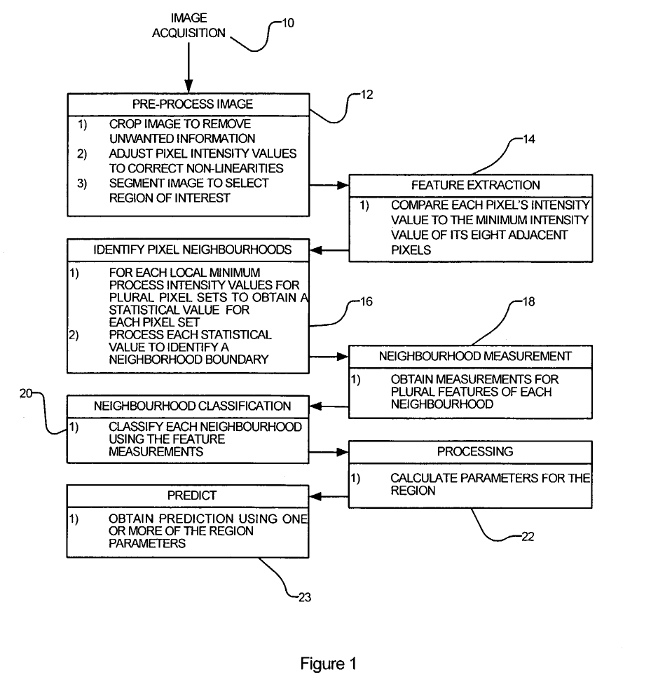

As is depicted in the flow diagram of FIG. 1, the preferred embodiment of the present invention includes a sequence of operations.

In a first step 10, a medical image (which in the preferred embodiment of the invention is a digital mammogram) is acquired using an acquisition step 10.

The step 10 of acquiring the digital mammogram may be performed by digitising an image contained in a mammogram film using a digitiser system, or as an output (for example, in the form of a computer readable image file) from a digital mammography system.

In the embodiment described, a digitiser system is used to scan the mammography film and convert it into a digital form thereby providing the digital mammogram (‘the digital image’). In this form, the digitiser system may be a Luminus Lumiscan 150 laser digitiser which is able to digitise the mammography film at 50μm spatial resolution and 12 bit depth.

In step 12, the digital image is pre-processed to select a region of interest. Pre-processing of the digital image preferably involves a cropping step 12-1 which removes unwanted information and restricts the digital image to the smallest rectangle which contains an entire breast. The pre-processing 12 may also entail and adjustment step 12-2 and a segmentation step 12-3.

In cases where the digital image is acquired using a system having a non-linear characteristic, the pre-processing step 12 includes step 12-2 in which the intensity values of the pixels in the cropped digital image are adjusted so as to correct non-linearities which may have been introduced during the step of acquiring the image.

Where required, the adjustment of the intensity values preferably entails measuring an intensity response curve for the system used to acquire the image, and defining a standard correction curve. Ideally, the intensity response curve is able to be measured using a step wedge. Intensity values are then able to be adjusted according to the standard correction curve.

The adjustment of intensity values preferably entails stretching the range of the intensity values to span a range of values, and then rounding each resulting value to integer values for efficient storage. In a system having intensity values which are represented using a 12 bit binary code, the range of values is 0 to 4095. It will be appreciated that in systems using other than a 12 bit binary code, the range of values may be correspondingly different.

Once the image has been cropped using step 12-1, and the pixel intensity values adjusted in accordance with the standard correction curve (if required) using step 12-2, the resulting image is then segmented using step 12-3 so as select a region of interest. In the case of a mammogram, the region of interest will be portion of the image which includes the breast tissue.

In the preferred embodiment of the invention, step 12-3 involves subsampling the cropped (and possibly adjusted) image using a subsampling factor, and converting it into a binary image using a thresholding process. In the preferred embodiment of the invention, a sub-sampling factor of 100 to 1 (that is, 10×10 patch to 1 pixel) is used.

The thresholding process preferably entails comparing each pixel intensity value of pixels in the sub-sampled image to a threshold value, and using the results of the comparisons to produce a binary image. In one implementation of the present invention, pixels in the sub-sampled image having an intensity value which exceeds a threshold value are converted to white, while the remainder are converted to black.

In the preferred embodiment, a single threshold value of 1000 is used. Although non-breast portions of the image routinely have intensity above 1000, the breast forms the largest connected component above this threshold.

The thresholding process is followed by a process in which the largest connected component in the binary image is selected, up-sampled and dilated using a circular structure element of radius 15 pixels. Advantageously, this technique provides a reasonable template of the breast.

Having selected the region of interest, local minima in the intensity surface of the region of interest are identified using a feature extraction process 14. Here, all single pixel local minima in the region of interest are identified by comparing each pixel's intensity values to a minimum intensity value determined for its eight adjacent pixels.

Having identified the single pixel local minima in the region, at step 16 a pixel neighbourhood is identified for each pixel having a local minimum intensity value.

In the preferred embodiment of the invention, step 16 involves a first processing step 16-1 and a second processing step 16-2 for each local minimum. In the first processing step 16-1, intensity values for plural pixel sets associated with a local minimum are processed.

Here, each pixel set has one of several non-overlapping paths. The paths are substantially concentric about the local minimum and substantially equally spaced.

In the preferred embodiment of the invention, the abovementioned paths are substantially circular such that each path prescribes a ‘ring’ about and centred on the associated local minimum. It is to be understood that although reference will be made to paths as being substantially circular, it is to be appreciated that other path geometries may also be used. Indeed, it is envisaged that path shapes such as polygons and ellipses may also be suitable. Clearly, such path shapes may require a different set of feature measurements according to the path geometry.

Step 16-1 preferably entails processing the intensity values for the pixels in each pixel set so as to provide a statistical value for each pixel set. In the preferred embodiment of the invention, the statistical value is the average pixel intensity of the set of pixels lying on the circular path.

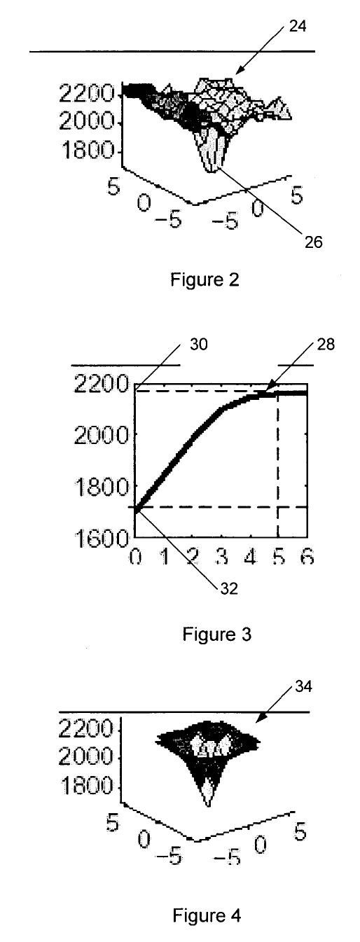

In the second processing step 16-2 the statistical values are processed so as to identify a neighbourhood boundary. Here, the statistical values associated with each plural pixel set are used to construct a respective average pixel value function similar to the illustrated function 28 (ref FIG. 3) for the intensity surface illustrated in FIG. 2.

Each average pixel value function is used to identify a neighbourhood associated with the local minimum of a respective pixel set. In the preferred embodiment of the invention, the smallest ring (that is, the ring having the smallest radius) for which average pixel value function is non-increasing is determined and taken to be the boundary of the neighbourhood associated with the local minimum.

Having described the process 16 of identifying pixel neighbourhoods, the description will now turn to the process 18 of obtaining measurements for plural features of each neighbourhood.

Referring now to FIG. 2, an intensity surface of a neighbourhood 24 having a local minimum 26 is shown.

In process 18, the average pixel value function constructed for each neighbourhood associated with a local minimum, is analysed so that the following feature measurements are able to be computed and recorded:

a. H=height;

b. R=radius;

c. S=symmetry; and

d. B=background.

The features H, R, S and B are neighbourhood features in that they specify properties of the group of pixels in a neighbourhood associated with a local minimum.

As is evident on inspection of the illustrated average pixel value functions 28, this function of initially increases.

Referring again to FIG. 3, the function 28 illustrated is strictly increasing on [0,5], thus in this example the neighbourhood 24 (refer FIG. 2) has a radius of (R) 5.

In relation to the determination of the height (H), and with reference again to FIG. 3, the difference between the value at the local minimum 32 and the average value 30 of the last increasing ring is taken as the height. Thus, in the example depicted, the height is approximately 475 (that is, H =2175−1700).

For the purposes of the present invention, symmetry (S) is defined as the average squared difference between the intensity surface (refer FIG. 2) for a neighbourhood and a local model of the intensity surface obtained by revolving the function of ring averages (refer FIG. 3) about the local minimum location.

This model represents an ideally symmetric local image surface having an identical average ring function as the neighbourhood 24.

Referring now to FIG. 4, there is illustrated a model of the intensity surface 24 (refer FIG. 2) obtained by revolving the function of ring averages 28 (refer FIG. 3) about the local minimum location 26 (refer FIG. 2).

In relation to the determination of a value for the background, the background is taken to be the average value of the largest increasing ring.

Referring back to FIG. 1, having obtained the feature measurements for each neighbourhood associated with a local minimum using process 18, each neighbourhood is then classified using process 20 into one of a plural of neighbourhood categories according to a comparison of neighbourhood feature measurements with predetermined feature criteria. In the preferred embodiment of the invention, the plural of categories having predetermined feature criteria are defined as:

a. : ₁┘H!19,R 1,Sδ150, B! 2100;

b. : ₂ ┘H!38,R 2,Sδ200,B! 2100; and

c. : ₃ ┘H !76,R 3,Sδ300,B! 2100.

The classification of each neighbourhood into one a plural of categories is preferably used to generate classification information. In this respect, the classification information includes statistical information derived from the classification process. Such statistical information may include, but not be limited to:

a. a total number of neighbourhoods in each category (that is, |: hd 1|,|: ₂| and |: ₃);

b. the heights (H) of the local minimum of the neighbourhoods in each category (that is, the set of heights for the neighbourhoods of a particular category); and

c. a total number of local minima in the region of interest.

To facilitate a prediction of whether the region of interest contains invasive lobular carcinoma, the classification information is preferably processed using process 22 so as to generate the following six region parameters:

$$\begin{matrix}{N}_{1} \vert : \frac{1}{N} \vert & {A}_{1} mean ⊥ H ( p ) : p {:}_{ 1} \\ {N}_{2} \vert : \frac{2}{N} \vert & {A}_{2} mean ⊥ H ( p ) : p {:}_{ 2} \\ {N}_{2} \vert : \frac{3}{N} \vert & {A}_{2} mean ⊥ H ( p ) : p {:}_{ 3}\end{matrix}$$

where N is a number which is representative of the total number of local minima in the region. Advantageously, in the preferred embodiment of the invention, normalization by N enables compensation for variation in a region's size (for example, breast size).

Having described the processes 12, 14, 16, 18 and 20, the description will now turn to a separate process which is performed in advance of these processes which is used to generate statistical data which is used by a prediction process 23 to provide an indication of the likelihood that cancer exists in the image.

Referring back to FIG. 1, in the embodiment described, the process 23 of predicting the presence of a cancer in the image relies upon retrieval of statistical data from a database which has been generated using an image library.

Ideally, images in the image library have been subjected to analysis of textural features so as to correlate region parameter values, and combinations of region parameter values, with a classification score which is representative of the likelihood of the region parameter value or values being indicative of cancer.

Preferably, the image library consists of ‘normal’ (that is, images which are known not to contain cancer) and ‘abnormal’ images (that is, images which are known to have contained cancer). Ideally, the analysis will provide a classification score for each of plural combinations of the region parameters.

Indeed, for the purposes of this description, the following sections will refer to statistical data which has been obtained using an image library which included twenty-four mammographic images representing twelve cases of invasive lobular carcinoma plus twenty-four normal images representing twelve women with no cancer.

In each of these cases, no evidence of cancer was found during screening, but invasive lobular carcinoma was detected and verified by histopathology within 2.5 years after screening. Normal images were included in the image library only if no evidence of cancer was found within three years after the date of image acquisition.

The evaluation of the classification scores for each single region parameter (herein referred to the ‘one-dimensional space’) and region parameter pairs (herein referred to as the ‘two-dimensional space’) will be now be described.

It is to be appreciated that, although the evaluation of the classification scores will be described in terms of ‘one-dimensional’ and ‘two-dimensional’ spaces, other dimensional spaces may also be used. However, in the preferred embodiment of the invention only one and/or two dimensional classification spaces are used.

The set of one-dimensional and two-dimensional space together result in twenty-one different classification spaces. That is, six one-dimensional spaces consisting of one of Ni or Ai i=1, 2, 3, and fifteen possible two-dimensional spaces.

For each of the twenty-one spaces, two measures are able to be used to evaluate the classification scores, namely:

a. the maximum rate of true detection at an operating point of zero false positive detections (dₒ); and

b. the area underneath an empirical ROC curve (P(A)) (refer to FIG. 6).

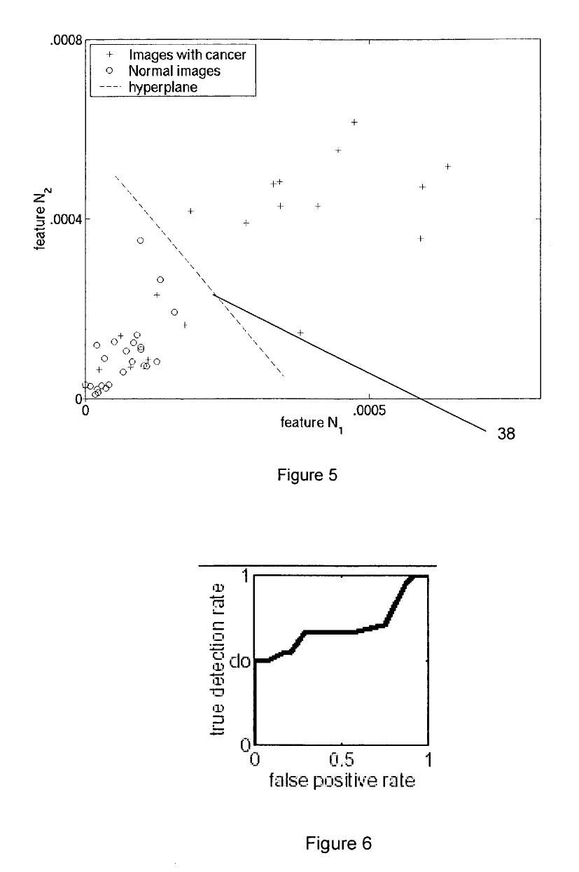

In the preferred embodiment, the measures dₒ and P(A) are computed using linear discriminant surfaces. By way of example, and referring to FIG. 5, there is depicted a scatter plot for the region parameters N1 and N2 as measured for images in the image library.

Here, images of breast tissue found to have contained invasive lobular carcinoma are marked ‘+’, images of breast tissue found to not have invasive lobular carcinoma are marked ‘o’. Thus, from inspection of FIG. 5, it is evident that the detection rate, dₒ, which is able to be obtained, whilst maintaining a zero false positive detection, is dₒ=0.5 (that is, twelve of the twenty-four‘abnormal’ images are detected correctly, and none of the 24 ‘normal’ images are detected as including invasive lobular carcinoma). In this case, for the image library, the linear discriminating surface 38 is as illustrated.

More explicitly, for a given unit direction vector u and distance to an origin s, let X be a hyperplane defined by:

X ⊥x:<x,u,>s

and let F u,s and T(u,s) denote the number of false positive detections and the number of true detection obtained by using X as a decision surface.

The maximum true detection rate at zero false positives, dₒ(u), and the area under the ROC curve, Pᵤ(A), in fixed direction u are defined by

$$\begin{matrix}{d}_{0} ( u ) {max}_{s} ⊥ T ( u , s ) : F ( u , s ) 0 \} \\ and \\ {P}_{u} ( A ) {max}_{s} ⊥ area under the curve ( F ( u , s ) , T ( u , s ) )\end{matrix}$$

The values dₒ and P(A) are subsequently defined by:

$$\begin{matrix}{d}_{0} {max}_{u} {d}_{0} ( u ) \\ and \\ P ( A ) {max}_{u} {P}_{u} ( A )\end{matrix}$$

In the preferred embodiment, the area under the curve (as required for the calculation of Pᵤ (A)) is able to be computed using a trapezoid rule on forty ROC points equally spaced with respect to the parameter s and, in the case of two dimensional spaces, the maxima required for the calculation of dₒ and P(A) were computed over two hundred equally spaced directions u.

The classification score, P(A), is similar to the A_{z} score often used in ROC analysis but, advantageously, does not presume a particular form of distribution of a decision variable.

The resultant classification scores dₒ and P(A), as determined for the twenty-one spaces derived from the image library are included in tables 1 and 2.

TABLE 1
Classification results for 1-D feature spaces.

| Parameter number | 1 | 2 | 3 | 4 | 5 | 6 |
|---|---|---|---|---|---|---|
| Parameter name | N1 | N2 | N3 | A1 | A2 | A3 |
| d₀ | 0.542 | 0.417 | 0.375 | 0 | 0.208 | 0.042 |
| P(A) | 0.667 | 0.672 | 0.688 | 0.560 | 0.525 | 0.508 |

TABLE 2

| Parameter | 1,2 | 1,3 | 1,4 | 1,5 | 1,6 | 2,3 | 2,4 | 2,5 | 2,6 | 3,4 | 3,5 | 3,6 | 4,5 | 4,6 | 5,6 |
|---|---|---|---|---|---|---|---|---|---|---|---|---|---|---|---|
| d₀ | 0.542 | 0.542 | 0.542 | 0.708 | 0.542 | 0.458 | 0.417 | 0.625 | 0.417 | 0.375 | 0.542 | 0.375 | 0.250 | 0.208 | 0.208 |
| P(A) | 0.695 | 0.694 | 0.890 | 0.867 | 0.795 | 0.707 | 0.882 | 0.867 | 0.779 | 0.840 | 0.828 | 0.774 | 0.627 | 0.663 | 0.648 |

The results recorded in tables 1 and 2 indicate that some parameters, and combinations thereof, are able to be used to predicting the presence of invasive lobular carcinoma in screening mammograms.

For example, the value of dₒ for parameter number 1 (N1), indicates that approximately half of the images with invasive lobular carcinoma present may be detected without any false alarms, simply by tabulating the fraction the local intensity minima satisfying the conditions of Ω₁ and comparing the result with the linear discriminant surface (that is, the hyperplane) used to attain d_{o.}

Accordingly, it appears that, of invasive lobular carcinomas that are occult at screening, approximately half may be detected using the inventive method described here without significant increase in the number of false positive reports. Thus, it is envisaged that the present invention will find particular application in the detection of invasive lobular carcinoma which may otherwise be difficult to detect.

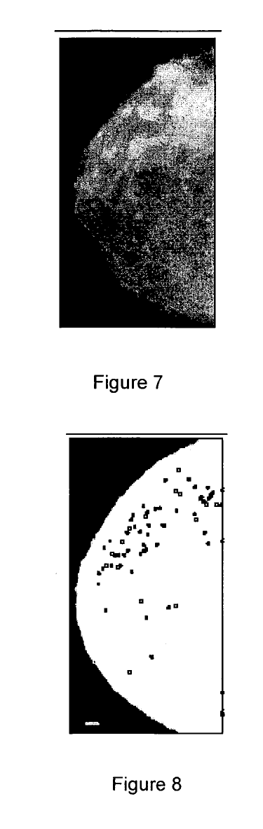

Indeed, with reference to FIG. 7 there is shown a representative invasive lobular carcinoma image from the image library. At screening this image was judged to be normal. Four months later a 45 mm carcinoma was found. In retrospect, radiologists with expertise in screening mammography could not find evidence of cancer when the entire screening mammogram was reviewed.

Turning now to FIG. 8, there is shown a binary image showing the breast region of FIG. 7 with locations of local minima satisfying the condition of Ω₁ marked ‘o’. The region of the image containing a high concentration of pixels in Ω₁ is consistent with the location of the carcinoma as recorded in a histopathology report.

Although the present invention has been described in terms of a preferred embodiment which is suitable for predicting the presence of invasive lobular carcinoma in a breast, by distinguishing the carcinoma from normal tissue, it will be appreciated that the invention may also be used to distinguish between two or more tissue types. In this respect, it is envisaged that the present invention may also be useful for the purpose of detecting other cancer types (for example, lung cancer and liver cancer). It is further envisaged that the present invention may be used with other image types (for example, CAT images).

The method of the present invention may be performed on a programmable apparatus equipped with software which is able to instruct the programmable apparatus to perform the inventive method.

The programmable apparatus may be a computer (for example, a desktop computer) having an executable program which is executable on the computer so as to enable the computer to perform the inventive method. Preparation of the executable program to provide the above described method is well within the capability of a skilled computer programmer.

The executable program will ideally reside on a computer readable memory. Any suitable computer readable memory may be used. Examples of suitable computer readable memories include a computer disk drive, a CD-ROM, DAT tape, FLASH memory, EPROM and the like.

Finally, it will be understood that there may be other variations and modifications to the configurations described herein that are also within the scope of the present invention.

the claims defining the invention are as follows:

1. A computerised method of analysing a medical image to detect the presence of a cancer having a radiographic density close to the radiographic density of normal tissue, the method including the steps of:
a. processing the image so as to obtain feature measurements for plural features of different pixel neighbourhoods within a region of the image, each pixel neighbourhood including a pixel having a local minimum intensity value;
b. using the feature measurements to classify each pixel neighbourhood as one of plural neighbourhood categories;
c. processing classification information for each neighbourhood category to thereby calculate parameters for the region; and
d. using at least one of the region parameters to predict the presence of a cancer.

2. A method according to claim 1 wherein processing the image includes:
a. processing intensity values for each pixel in a pixel set associated with a respective single pixel having a local minimum intensity value;
b. obtaining a statistical value for each pixel set so as to identify a neighbourhood boundary for each set; and
c. obtaining feature measurements for plural features of each neighbourhood defined by a neighbourhood boundary.

3. A method according to claim 1 wherein the neighbourhood classification information includes:
a. the total number of neighbourhoods in each category; and
b. the set of heights (H) of the neighbourhood boundaries of each neighbourhood in a particular neighbourhood category, the heights being relative to the respective local minimum intensity value.

4. A method according to claim 3 wherein the region parameters include:
a. a mean height for each neighbourhood category; and
b. a normalised category count for each neighbourhood category.

5. A method according to claim 4 wherein using at least one of the region parameters to predict the presence of cancer in the image includes comparing at least some of the region parameters of the image with equivalent region parameters for images in which cancer has been detected.

6. A computerised method of analysing a medical image to detect the presence of a cancer having a radiographic density close to the radiographic density of normal tissue, the method including the steps of:
a. pre-processing the image to select a region, the region including a plurality of pixels, each pixel having an intensity value;
b. identifying pixels in the region having a local minimum intensity value;
c. for each identified pixel having a local minimum intensity value, identifying an associated pixel neighbourhood;
d. for each identified neighbourhood:
i. obtaining measurements for plural features of the neighbourhood; and
ii. using the feature measurements to classify the neighbourhood, thereby providing neighbourhood classification information;
e. processing the neighbourhood classification information to calculate parameters for the region; and
f. using at least one of the region parameters to predict the presence of a cancer.

7. A method according to claim 6 wherein the step of pre-processing the image to select a region may further include processing the image to correct non-linearities.

8. A method according to claim 7 wherein the correction of non-linearities includes modifying the intensity values for pixels in the image using a correction function to thereby provide modified image pixel intensity values.

9. A method according to claim 6 wherein the pre-processing of the image to select a region includes:
a. sub-sampling the image to provide a sub-sampled image;
b. thresholding the sub-sampled image using a selected threshold value, the thresholding providing a modified sub-sampled image;
c. selecting the largest connected component in the modified sub-sampled image;
d. up-sampling the modified sub-sampled image to provide an up-sampled image; and
e. dilating the up-sampled image using a dilation element.

10. A method according to claim 9 wherein sub-sampling includes replacing plural arrays of image pixels with a respective single pixel, each single pixel having an intensity value which is equal to the average of intensity value pixels in a respective array.

11. A method according to claim 10 wherein each array is a square array.

12. A method according to claim 11 wherein the square array is a 10×10 array of pixels.

13. A method according to claim 9 wherein thresholding includes:
a. assigning a binary ‘zero’ value to pixels in the sub-sampled image having an intensity value which is less than a selected threshold value; and
b. assigning a binary ‘one’ value to pixels in the sub-sampled image having an intensity value above the threshold value.

14. A method according to claim 9 wherein up-sampling includes replacing each pixel in the modified sub-sampled image with an array of pixels.

15. A method according to claim 14 wherein the array is a square array.

16. A method according to claim 9 wherein modifying the up-sampled image includes using a dilation element such that pixels in the up-sampled image having a zero value within a zone defined by the dilation element are assigned a non-zero value if another pixel within the zone defined by the dilation element also has a non-zero value.

17. A method according to claim 16 wherein the dilation element is a circular dilation element having a predetermined radius.

18. A method according to claim 6 wherein identifying pixels in the region having a local minimum intensity value includes identifying single pixel local minima in an intensity surface of the region.

19. A method according to claim 18 wherein identifying pixels in the region having a local minimum intensity value entails processing the pixel intensity values to identify pixels in the region having an intensity value which is less than the intensity values of adjacently located pixels.

20. A method according to claim 6 wherein identifying a pixel neighbourhood for each pixel having a local minimum intensity value includes:
a. processing intensity values for plural pixel sets, each pixel set having one of several non-overlapping paths, each path being substantially concentric about the local minimum, and substantially equally spaced, wherein the processing provides a statistical value for each pixel set; and
b. processing each statistical value to identify a neighbourhood boundary.

21. A method according to claim 20 wherein the paths are substantially circular.

22. A method according to claim 21 wherein the statistical value is the average pixel intensity value for the pixels in a pixel set.

23. A method according to claim 22 wherein the processing of the statistical values to identify a neighbourhood boundary includes comparing statistical values from adjacent pixel sets so as to identify a minimum difference between the statistical value of adjacent pixel sets.

24. A method according to claim 23 wherein the neighbourhood boundary is the path having a statistical value which is different from the statistical value of a smaller adjacent path by an amount which is less than the minimum difference.

25. A method according to claim 24 wherein the plural feature measurements include:
a. a value which is representative of the height (H) of the neighbourhood boundary relative to the local minimum intensity value of a pixel neighbourhood;
b. a value (R) which is representative of the radius (R) of the circular path about the pixel having the local minimum intensity value
c. a value (S) which is representative of the symmetry (S) of an intensity surface formed using statistical values of the pixel sets; and
d. a value (B) which is representative of the intensity value of a background about the pixel neighbourhood.

26. A method according to claim 25 wherein the height is computed as a difference between the average pixel value for pixels located on the boundary and the pixel intensity value of the single pixel local minimum in the neighbourhood.

27. A method according to claim 25 wherein the symmetry is computed using an average squared difference between the local intensity surface and a local model of the intensity surface obtained by revolving a function of the statical values about the single pixel local minimum.

28. A method according to claim 25 wherein the background is computed using the statistical value of the neighbourhood boundary.

29. A method according to claim 6 wherein the classifying of a neighbourhood using the feature measurements includes:
a. categorising each identified neighbourhood into a neighbourhood category according to a comparison of a neighbourhood's respective feature measurements with plural sets of predetermined feature criteria; and
b. for each neighbourhood which is categorised using a neighbourhood category, incrementing a category count for the respective neighbourhood category.

30. A method according to claim 25 wherein the classifying of a neighbourhood using the feature measurements includes:
a. categorising each identified neighbourhood into a neighbourhood category according to a comparison of a neighbourhood's respective feature measurements with plural sets of predetermined feature criteria; and
b. for each neighbourhood which is categorised using a neighbourhood category, incrementing a category count for the respective neighbourhood category.

31. A method according to claim 30 wherein the plural sets of predetermined feature criteria include:
Ω₁={H>19, R=1, S<150, B>2100} a.
Ω₂={H>38, R=2, S<200, B>2100}; and b.
Ω₃={H>76, R=3, S<300, B>2100} c.
wherein Ω_{1, Ω}₂ and Ω₃ are neighbourhood categories.

32. A method according to claim 6 wherein the neighbourhood classification information includes:
a. the total number of neighbourhoods in each category; and
b. the set of heights (H) of the neighbourhood boundaries of each neighbourhood in a particular neighbourhood category, the heights being relative to the respective local minimum intensity value.

33. A method according to claim 6 wherein the calculation of region parameters uses classification information obtained for at least one neighbourhood category.

34. A method according to claim 33 wherein the region parameters include:
a. a mean height for each neighbourhood category; and
b. a normalised category count for each neighbourhood category.

35. A method according to claim 6 wherein the prediction includes providing an indication of the likelihood that cancer exits in the image.

36. A computerised method of analysing a digital mammogram to detect the presence of an invasive lobular carcinoma in human breast tissue, the method including the steps of:
a. processing an image file for the digital mammogram so as to obtain feature measurements for plural features of different pixel neighbourhoods within a region of the digital mammogram, each pixel neighbourhood including a pixel having a local minimum intensity value;
b. using the feature measurements to classify each pixel neighbourhood as one of plural neighbourhood categories;
c. processing classification information for each neighbourhood category to thereby calculate parameters for the region; and
d. using at least one of the region parameters to predict the presence of an invasive lobular carcinoma.

37. A computer readable memory encoded with data representing a computer program executable to make a computer execute a method according to claim 1.

38. A computer readable memory encoded with data representing a computer program executable to make a computer execute a method according to claim 6.

39. A computer readable memory encoded with data representing a computer program executable to make a computer execute a method according to claim 36.

40. A system for analysing a medical image to detect the presence of a cancer having a radiographic density close to close to the radiographic density of normal tissue, the system including:
a. a programmable computer;
b. computer software installed onto the programmed computer, the computer software enabling the programmed computer to:
process the image so as to obtain feature measurements for plural features of different pixel neighbourhoods within a region of the image, each pixel neighbourhood including a pixel having a local minimum intensity value;
use the feature measurements to classify each pixel neighbourhood as one of plural neighbourhood categories;
process classification information for each neighbourhood category to thereby calculate parameters for the region; and
use at least one of the region parameters to predict the presence of a cancer.
